(19) United States
(12) Patent Application Publication
(10) Pub. No.: US 2025/0361079 A1
(43) Pub. Date: Nov. 27, 2025

(54) Modular Storage Robot Mechanism

(71) Applicant: Summersun Intelligent Technology (Suzhou) Co., Ltd., Suzhou (CN)

(72) Inventor: Gaojian Zhang, Suzhou (CN)

(21) Appl. No.: 19/020,161

(22) Filed: Jan. 14, 2025

(30) Foreign Application Priority Data
May 22, 2024 (CN) 2024211267689

(51) Int. Cl. B65F 1/06; B65F 1/00; B65F 1/16

(52) U.S. Cl. CPC B65F 1/065; B65F 1/002; B65F 1/1638; B65F 2210/137; B65F 2210/167; B65F 2210/179; B65F 2210/188

(57) ABSTRACT

This invention provides a modular storage robot device, including a storage bucket body, the top of which is detachably connected to a storage flip cover assembly. storage flip cover assembly includes a support cover, the middle of which is provided with a storage bag mounting mechanism. The bottom of the storage bag mounting mechanism is provided a packaging device, and the side of the packaging device is provided with a negative pressure device. This is used to solve the current market automatic packaging trash can are all design, the bucket body, packaging mechanism, bag loading mechanism and flip cover are assembled as a whole, difficult to disassemble, large transportation volume, high transportation cost at the same time, since the automatic packaging system is not modular design, its commonality and compatibility are poor.

### TECHNICAL FIELD

The invention mainly relates to the field of storage robot technology, and specifically relates to a modular storage robot mechanism.

### BACKGROUND OF THE PRESENT INVENTION

At present, the automatic packing and automatic bagging intelligent trash can system in the market is designed as a whole, and the bucket body, packing mechanism, bagging mechanism and lid are combined together and cannot be separated.

In the course of operating the specific embodiment, the inventor discovered the following defects:

This intelligent storage robot mechanism system has a large volume and high space occupation rate is relatively complex making production and assembly difficult and occupies a considerable volume during transportation leading to higher transportation costs; meanwhile due to the automatic packaging system not being modularly designed its commonality and compatibility are relatively poor which is not conducive to standardized configuration.

It should be noted that the above content belongs to the technical cognition of the inventor. Because the technical content in this field is vast and complex, the above content of the application does not necessarily constitute the existing technology.

### SUMMARY OF PRESENT INVENTION

### 1. The Technical Problem to be Solved by the Invention

The invention provides a modular storage robot mechanism to solve the technical problems existing in the background technology.

### 2. Technical Solutions

To achieve the above objectives, the technical solution provided by this invention is as follows: a modular storage robot mechanism, including a storage bucket, the top of which can be disassembled and connected to a storage flip cover assembly. The storage flip cover assembly comprises a support cover, with the installation mechanism for storing bags located in the middle of the support cover. At the bottom of the installation mechanism for storing bags is a sealing packaging device, and on the side of the sealing packaging device is a negative pressure device. Both the installation mechanism for storing bags and the sealing packaging device are located at the top of the storage bucket and can be disassembled from the storage bucket. The bucket structure is simple and interchangeable, allowing for individual transportation. If the bucket is damaged, it can be shipped separately; if the storage flip cover assembly is damaged, it can also be shipped separately. The commonality and compatibility are good, facilitating standardized configuration. Assembly is relatively simple, requiring only the placement of the storage flip cover assembly on top of the storage bucket, which improves transportation efficiency when transported separately.

Furthermore, the rear end of the support cover is provided with a concave groove, and a concave positioning plate is symmetrically set on the inner side of the concave groove. The concave positioning plate is fixedly connected to the support column, which rotates and connects to the support block. The bottom of the support block is equipped with a concave plug-in block, which can be disassembled and connected to the storage drum.

Further, the said storage cover integral component can be placed inside the storage barrel.

Further, the inner side wall of the storage barrel is provided with a concave groove, and the concave groove is slidingly connected with the concave plug.

Further, the support cover is connected to the sealing cover on the top side, and the storage bag mounting mechanism is set at the bottom of the sealing cover. The storage bag mounting mechanism includes a curved storage plate, and the top of the curved storage plate is provided with a curved cover plate.

Further, the sealing packaging device includes a driving device, the bottom of which is provided with two output shafts with different transmission directions, the output shafts are respectively connected to the end of the first synchronous belt and the end of the second synchronous belt;
as well as the first sealing plate and the second sealing plate, which are respectively connected to the first synchronous belt and the second synchronous belt; the first synchronous belt and the second synchronous belt are rotatively connected to a fixing structure at the other end, which is set at the bottom of the support cover;

The first sealing plate has a first sliding groove in the middle, the second sealing plate is slidingly connected to the first sliding groove, and the end part of the first sealing plate and the second sealing plate are respectively provided with sliding clamps and two synchronous belts;

It also includes a sliding column, which is set on the side of the driving device, and which is matched to connect the sliding clamping block;

It also includes a third sealing plate, which is connected to the other side of the first synchronous belt by a second clamp;

The third sealing plate has a second sliding groove in the middle thereof, the second sliding groove is slidingly connected to the second sealing plate, a heat seal block is set between the first sealing plate and the third sealing plate, and a corresponding heat seal opening is opened on the second sealing plate.

Further, the negative pressure device includes a working plate, the top of which is connected to the bottom of the support cover, an exhaust fan is provided on the working plate, and an exhaust hole is opened at the corresponding position on the side of the support cover.

The said integrated cover and the said storage barrel can be stacked together or connected by a connecting support block; the said integrated cover can be disassembled and placed in the said storage barrel.

The heat seal block can be disassemblably connected to the bottom of the support cover, so as to facilitate the quick disassembly, maintenance and replacement of the heat seal block. It should be noted that the heat seal block can also be fixed to the bottom of the support cover.

### 3. Beneficial Effects

The technical solution provided by the invention has the following beneficial effects compared with the existing technology:

This invention is reasonably designed, mainly consisting of an integrated cover and storage container, with both the storage sealing structure and the integrated cover being housed within it. The overall structure is modular, facilitating transportation and installation. Both the integrated cover and storage container can be shipped separately, offering good compatibility and ease of standardized configuration.

During transportation, the integrated storage lid can be directly placed in the storage barrel to save transportation space and reduce transportation cost. The integrated storage lid is assembled conveniently by inserting the concave plug into the storage barrel

It should be noted that the structures not introduced in this invention are the same as the existing technology or can be implemented by the existing technology, and are not described in detail here because they do not involve the design points and improvement directions of this invention.

### BRIEF DESCRIPTION OF THE DRAWINGS

FIG. 1 is a structural diagram of the invention;

FIG. 2 is a schematic diagram of the structure of the integrated cover component of the invention and the separation from the storage barrel;

FIG. 3 is a schematic diagram of another structural angle of the invention;

FIG. 4 is a top structure diagram of the integrated cover assembly of the invention;

FIG. 5 is a schematic diagram of the sealing packaging structure of the invention;

FIG. 6 is a schematic diagram of the bottom structure of the integrated cover assembly of the invention;

FIG. 7 is a structural diagram of the embodiment of the invention when the integrated cover component is placed into the storage cylinder.

### Attached Figure Marks:

1. Storage Bin Body; 11. Concave Card Slot; 2. Storage Flip Lid Integral Assembly; 3. Support Cover; 31. Concave Slot; 32. Concave Positioning Plate; 33. Support Column; 34. Support Block; 35. Concave Insertion Block; 4. Storage Bag Installation Mechanism; 5. Sealing Packaging Device; 51. Drive Unit; 52. First Synchronous Belt; 53. Second Synchronous Belt; 54. First Sealing Plate; 541. First Sliding Slot; 55. Second Sealing Plate; 56. Fixing Structure; 57. Sliding Column; 561. Sliding Clamp; 58. Third Sealing Plate; 581. Second Clamp; 582. Second Sliding Slot; 583. Heat Seal Block; 584. Heat Seal Port; 6. Negative Pressure Device; 61. Working Plate; 62. Exhaust Fan; 63. Exhaust Port; 71. Sealing Cover; 72. Herringbone Storage Board; 73. Herringbone Cover Plate.

### DETAILED DESCRIPTION OF THE EMBODIMENT'S

To facilitate understanding of the present invention, the following description will refer to relevant drawings providing several embodiments of the invention, however, the invention can be implemented in many different forms and is not limited to the embodiments described herein; rather, the purpose of providing these embodiments is to make the disclosure of the present invention more thorough and comprehensive.

In the description of this invention it should be understood that the terms “center” “longitudinal” “transverse” “length” “width” “thickness” “above” “below” “front” “rear” “left” “right” “vertical” “horizontal” “page” “bottom” “inside” “outside” “clockwise” “counterclockwise” etc. indicate directional or positional relationships based on the directional or positional relationships shown in the drawings they are provided merely for the convenience of describing the invention and simplifying the description and do not imply or suggest that the devices or components referred to must have specific orientations or be constructed and operated in specific orientations therefore they should not be construed as limiting the invention.

In addition, the terms “first” and “second” are used only for descriptive purposes and should not be interpreted as indicating or suggesting relative importance or implying the number of the indicated technical features. Therefore, features designated with “first” or “second” can explicitly or implicitly include one or more such features. In the description of this invention, the term “multiple” means two or more unless otherwise specifically defined.

In this invention, unless otherwise explicitly specified and limited, the terms “installed”, “connected”, “linked”, “fixed”, “provided”, and “set” should be understood in a broad sense, for example, they can be fixed connections, removable connections, or integral connections; they can be mechanical connections or electrical connections; they can be direct connections or indirect connections through intermediaries, and they can be internal connections between two components. For ordinary technical personnel in this field, the specific meanings of the above terms in this invention can be understood according to specific circumstances.

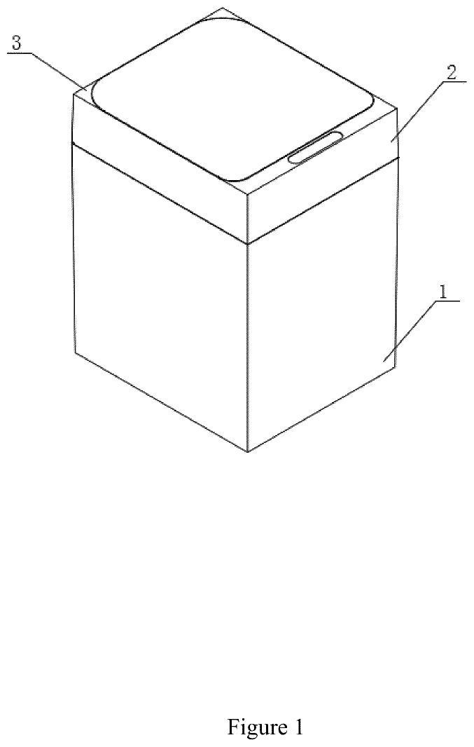

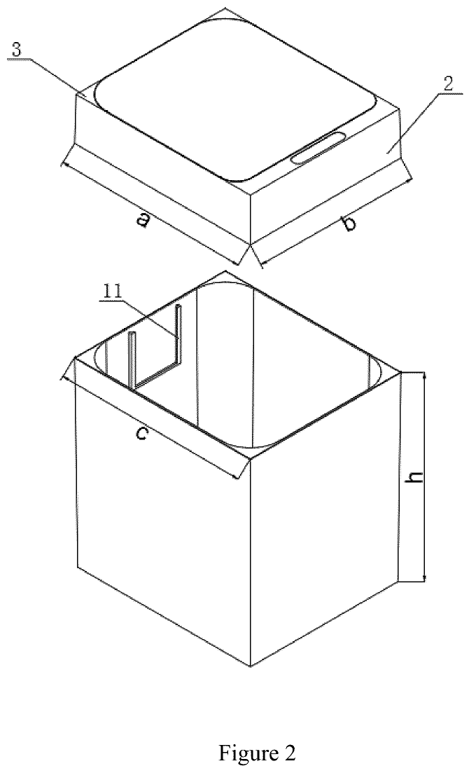

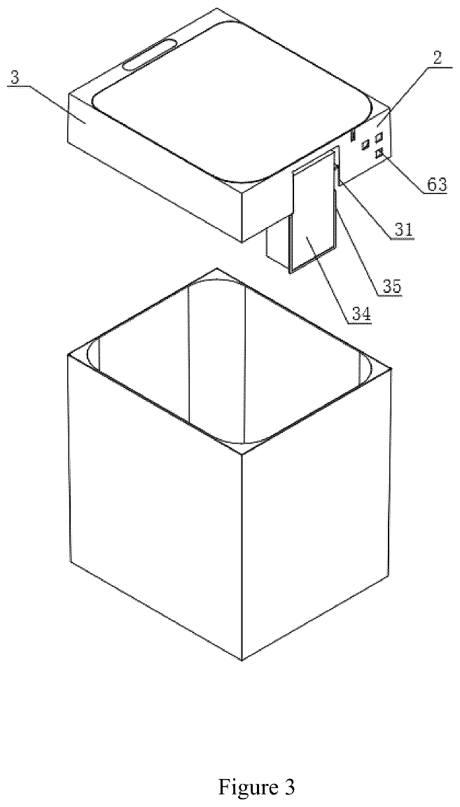

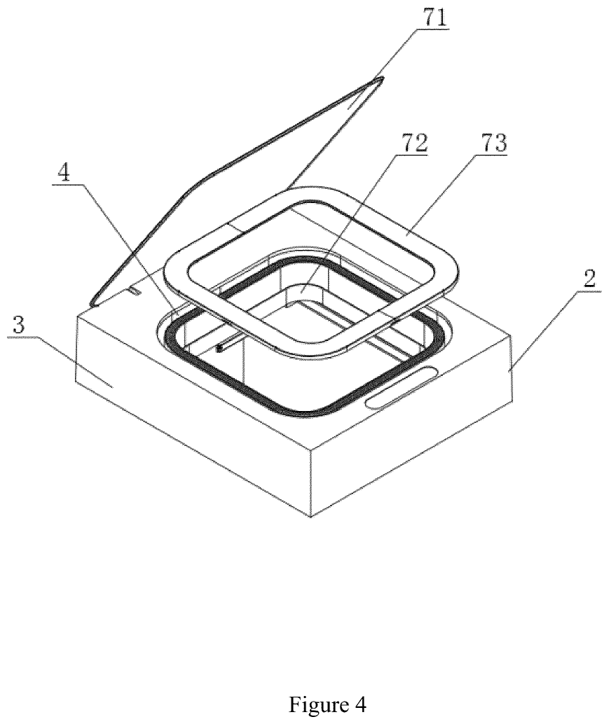

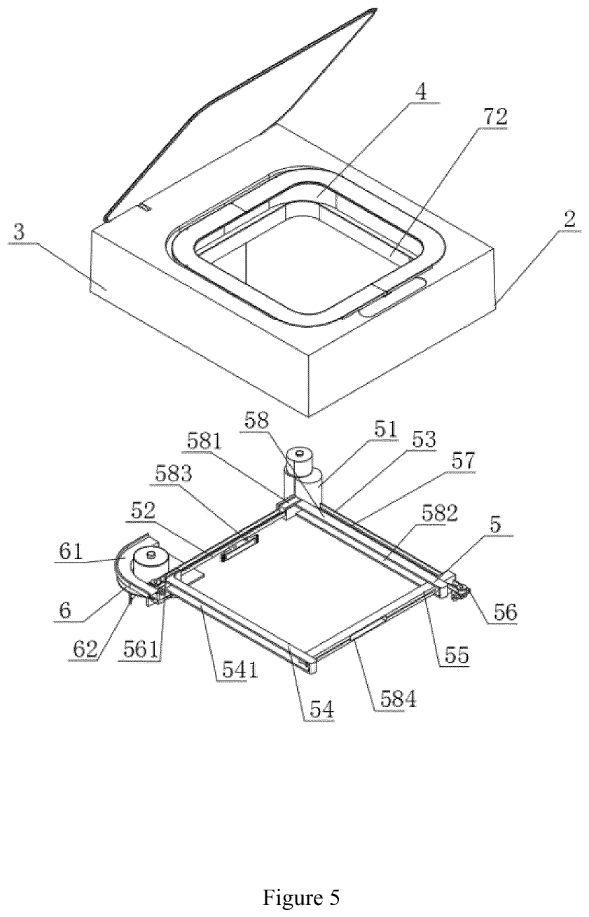

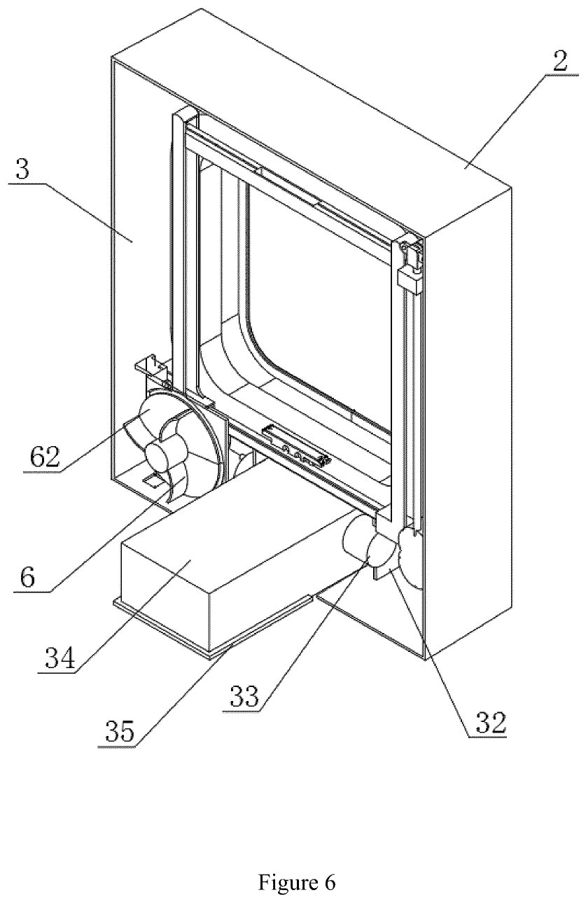

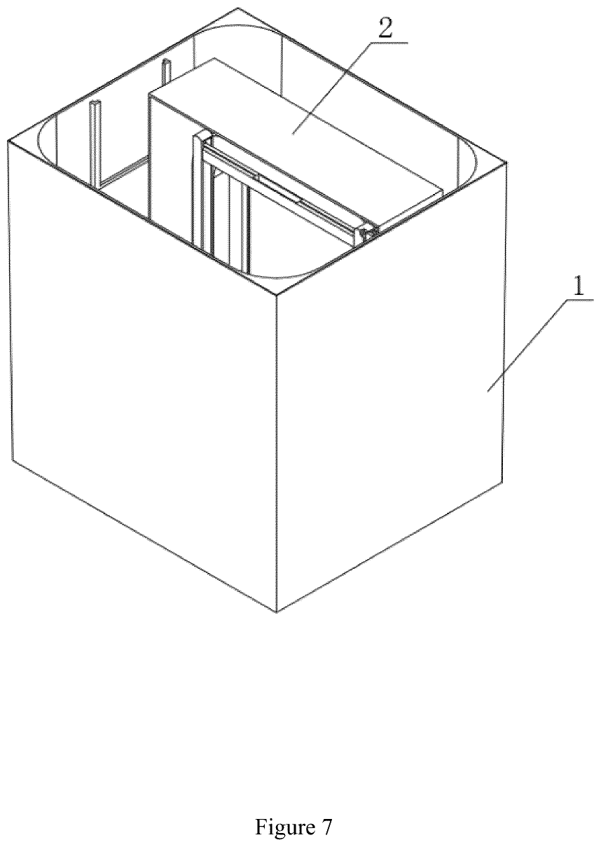

Referring to FIGS. 1-7, a modular storage robot mechanism includes a storage bucket 1, the top of which can be disassembled and connected to an integrated storage lid component 2. The integrated storage lid component 2 comprises a support cover 3, and the middle part of the support cover 3 is equipped with a storage bag installation mechanism 4. At the bottom of the storage bag installation mechanism 4 is a sealing packaging device 5, and on the side of the sealing packaging device 5 is a negative pressure device 6. Both the storage bag installation mechanism 4 and the sealing packaging device 5 are installed on the top of the storage bucket 1 and can be disassembled from it. The bucket structure is simple and interchangeable, allowing for individual transportation. If the bucket is damaged, it can be sent as a separate unit; if the integrated storage lid component 2 is damaged, it can also be shipped separately. This design ensures good compatibility and standardization, making assembly relatively simple by simply placing the integrated storage lid component 2 on top of the storage bucket 1, which facilitates transportation efficiency when transported separately.

The rear end of the support cover 3 has a recessed groove 31, and a recessed positioning plate 32 is symmetrically set on the inner side of the recessed groove 31. The recessed positioning plate 32 is fixedly connected to the support column 33, which rotates and connects to the support block 34. The bottom of the support block 34 has a recessed plug-in block 35, which can be disassembled and connected to the storage bucket 1. When installing the integrated component of the storage flip cover, insert the recessed plug-in block 35 into the storage bucket 1 to complete installation. To remove the packed garbage bag, flip the support cover 3 upward, and it will rotate along the support column 33 to open and facilitate the removal of the garbage bag. The support block 34 can be equipped with a rotating motor that meshes with the support column 33 through gears, achieving automatic opening and closing of the cover.

The integrated cover component 2 can be placed inside the storage bin 1, the internal length of the storage bin 1 is greater than or equal to the width of the integrated cover component 2, for example, in the following embodiment, the height h of the storage bin 1 is greater than the length a of the integrated cover component 2, the internal length c of the storage bin 1 is greater than the width b of the integrated cover component 2, to facilitate the storage and transportation of the entire device, the size of the integrated cover component 2 can be placed inside the storage bin 1 for packing, thus further utilizing the conveying space and reducing transportation costs, when the storage robot needs to be moved, the support cover 3 of the integrated cover component 2 can be removed from inside the storage bin 1 and stacked for conveying.

The inner side wall of the storage bin 1 is equipped with a concave slot 11, which is slideably connected to the concave plug block 35. All structures of this device are integrated within the storage flip cover assembly 2. During installation, it is only necessary to insert the support block 34 into the concave slot 11 of the storage bin. The entire device is modularly designed for easy installation.

The support cover 3 is connected to the sealing cover 71 on one side at the top, and the storage bag installation mechanism 4 is installed at the bottom of the sealing cover 71. The storage bag installation mechanism 4 includes a U-shaped storage board 72, and the top of the U-shaped storage board 72 is equipped with a U-shaped cover plate 73. The U-shaped storage board 72 can accommodate a smart garbage bag box when installed. Simply place the smart garbage bag box inside the U-shaped storage board 72 and cover it with the U-shaped cover plate 73.

The sealing packing device 5 includes a driving device 51, which has two output shafts with different transmission directions at the bottom of the driving device 51, and the output shafts are respectively connected to the end of the first synchronous belt 52 and the end of the second synchronous belt 53;

As well as the first sealing plate 54 and the second sealing plate 55, which are respectively connected to the first synchronous belt 52 and the second synchronous belt 53; the first synchronous belt 52 and the second synchronous belt 53 are rotatively connected to a fixing structure 56 at their other ends, which is set at the bottom of the support cover 3;

The first sealing plate 54 has a first sliding groove 541 in the middle, and the second sealing plate 55 is slidingly connected to the first sliding groove 541. The end part of the first sealing plate 54 and the end part of the second sealing plate 55 are respectively provided with sliding clamps 561 and two synchronous belts;

It also includes a sliding column 57, which is set on the side of the drive unit 51, and the sliding column 57 is matched and connected to the sliding block 561;

It also includes a third sealing plate 58, which is connected to the other side of the first synchronous belt 52 through a second clamp 581;

The third sealing plate 58 has a second sliding groove 582 in its middle, the second sliding groove 582 is slidingly connected to the second sealing plate 55, a heat sealing block 583 is set between the first sealing plate 54 and the third sealing plate 58, and a corresponding heat sealing port 584 is opened on the second sealing plate 55.

The fixed structure 56 includes a positioning block, the top of which is rotatively connected to a rotating shaft, the rotating shaft is matched and connected to the first synchronous belt 52 and the second synchronous belt 53, installation blocks are provided on both sides of the positioning block, the second clamping block 581 is slidably connected to the sliding column 57, and the first synchronous belt 52 and the second synchronous belt 53 are mutually perpendicular.

The second sealing plate 55 and the third sealing plate 58 move relatively under the drive of the first synchronous belt 52. The drive unit 51 can use a dual-head motor or combine two motors for driving in two directions. During operation, the two synchronous belts run in opposite directions, thus bringing the mutually perpendicular first sealing plate 54 and the second sealing plate 55 closer or farther apart, thereby folding the garbage bag. The fold point will be located at the midpoint of the first sealing plate 54, and after the heat seal point 584 combines with the heat seal block 583, the heat sealing operation is completed.

The negative pressure device 6 includes a working plate 61, the top of which is connected to the bottom of the support cover 3, and an exhaust fan 62 is installed on the working plate 61. The side of the support cover 3 has an exhaust hole 63 at the corresponding position. When the garbage bag is placed inside the trash can, to ensure the garbage bag quickly adheres to the bucket wall, the exhaust fan 62 is activated to expel internal air through the exhaust hole 63, facilitating the replacement and fitting of the garbage bag.

The integrated cover component 2 and the storage bucket 1 can be stacked together or connected by a connecting support block 34; the integrated cover component 2 can be disassembled and placed inside the storage bucket when stacked together with the storage bucket 1, and when the integrated cover component 2 and the storage bucket 1 are stacked together, the storage bucket 1 can be directly placed on top of the integrated cover component 2, and the top of the storage bucket 1 can interlock with the bottom of the integrated cover component 2.

The heat seal block 583 can be disassemblably connected to the bottom of the support cover 3 to facilitate the quick disassembly, maintenance and replacement of the heat seal block 583. It should be noted that the heat seal block 583 can also be fixed to the bottom of the support cover 3.

The above-described embodiments merely express a certain implementation method of this invention, their descriptions are relatively specific and detailed, but this does not mean that they should be understood as limiting the scope of this invention; it should be noted that for ordinary technical personnel in this field, various modifications and improvements can be made without departing from the conception of this invention, all of which fall within the scope of protection of this invention; therefore, the scope of protection of this invention should be determined by the accompanying claims.

1. A modular storage robot mechanism characterized in that it comprises a storage bucket (1) with a top that can be disassembled and connected to a storage flip cover assembly (2) which includes a support cover (3) with a storage bag installation mechanism (4) mounted in the middle of the support cover (3) and a sealing packaging device (5) mounted at the bottom of the storage bag installation mechanism (4) and a negative pressure device (6) mounted on the side of the sealing packaging device (5).

2. According to the modular storage robot mechanism of claim 1, the characteristic lies in: the support cover (3) has a recessed groove (31) at its rear end, and a concave positioning plate (32) is symmetrically set on the inner side of the recessed groove (31), the concave positioning plate (32) is fixedly connected to the support column (33), the support column (33) is rotatably connected to the support block (34), the bottom of the support block (34) has a concave plug-in block (35), and the concave plug-in block (35) is removably connected to the storage drum (1).

3. According to a modular storage robot mechanism as claimed in claim 1, the characteristics thereof are as follows:
The said storage cover integral component (2) can be placed in the interior of the said storage barrel (1).

4. According to claim 2, a modular storage robot mechanism is provided, characterized in that: the inner side wall of the storage barrel (1) has a concave slot (11), and the concave slot (11) is slidingly connected to the concave plug (35).

5. According to the modular storage robot mechanism of claim 1, the characteristic lies in: the support cover (3) is rotatively connected to the sealing cover (71) on one side at the top, the storage bag installation mechanism (4) is installed at the bottom of the sealing cover (71), the storage bag installation mechanism (4) includes a U-shaped storage plate (72), and the U-shaped storage plate (72) has a U-shaped cover plate (73) on its top.

6. According to the modular storage robot mechanism of claim 1, its characteristics lie in: the sealing packaging device (5) comprises a drive unit (51), and the bottom of the drive unit (51) is provided with two output shafts of different transmission directions, the output shafts are respectively connected to the ends of the first synchronous belt (52) and the second synchronous belt (53);
As well as the first sealing plate (54) and the second sealing plate (55), they are respectively connected to the first synchronous belt (52) and the second synchronous belt (53); the other end of the first synchronous belt (52) and the second synchronous belt (53) is rotatively connected to a fixing structure (56), which is set at the bottom of the support cover (3);
The first sealing plate (54) has a first sliding groove (541) in its middle, the second sealing plate (55) is slidingly connected to the first sliding groove (541), and the end parts of the first sealing plate (54) and the second sealing plate (55) are respectively provided with sliding clamps (561) and two synchronous belts;
It also includes a sliding column (57) disposed on the side of the drive unit (51), and the sliding column (57) is matched to connect the sliding block (561);
It also includes a third sealing plate (58), the third sealing plate (58) being connected to the other side of the first synchronous belt (52) by a second clamp (581);
The third sealing plate (58) has a second sliding groove (582) in its middle, which is slidably connected to the second sealing plate (55); a heat seal block (583) is set between the first sealing plate (54) and the third sealing plate (58), and a corresponding heat seal port (584) is provided on the second sealing plate (55).

7. According to the modular storage robot mechanism of claim 1, the characteristic lies in: the negative pressure device (6) comprises a working plate (61), the top of which is connected to the bottom of the support cover (3), an exhaust fan (62) is provided on the working plate (61), and an exhaust hole (63) is provided at the corresponding position on the side face of the support cover (3).

8. According to the modular storage robot mechanism as claimed in claim 1, the characteristics thereof are as follows: the storage cover integral component (2) and the storage barrel (1) can be stacked together through the connection support block (34).

9. According to claim 6, a modular storage robot mechanism is provided, characterized in that the heat seal block (583) is detachably connected to the bottom of the support cover (3).
